(19) United States
(12) Patent Application Publication
(10) Pub. No.: US 2009/0031720 A1
(43) Pub. Date: Feb. 5, 2009

(54) Hydraulic circuit for heavy equipment having variable control device

(75) Inventor: Young Jin Son, Changwon-si (KR)

Correspondence Address: LADAS & PARRY LLP, 26 WEST 61ST STREET, NEW YORK, NY, 10023, US

(73) Assignee: VOLVO CONSTRUCTION EQUIPMENT HOLDING SWEDEN AB.

(21) Appl. No.: 12/218,702

(22) Filed: Jul. 17, 2008

(30) Foreign Application Priority Data
Jul. 30, 2007 (KR) 10-2007-0076442

(51) Int. Cl. F15B 21/08

(52) U.S. Cl. 60/420

(57) ABSTRACT

A hydraulic circuit for heavy equipment having a variable control device is provided, in which variable relief valves for variably controlling operating pressure and flow rate of an option attachment are installed inside a main control valve, and pressure of the variable relief valves is variably controlled through selection of a preset option working mode. The hydraulic circuit includes at least one variable displacement hydraulic pump; a main relief valve installed on an upstream side of a discharge flow path of the hydraulic pump; an option attachment connected to the hydraulic pump; a main control valve installed in a flow path between the hydraulic pump and the option attachment; port relief valves, installed inside the main control valve, for being proportionally controlled so as to variably control relief pressure required for the option attachment in accordance with pilot signal pressure inputted from an outside; and a proportional relief valve, installed outside the main control valve, for variably controlling the pilot signal pressure inputted to the port relief valves in accordance with an electric signal inputted from an outside.

### CROSS-REFERENCE TO RELATED APPLICATION

This application is based on and claims priority from Korean Patent Application No. 10-2007-0076442, filed on Jul. 30, 2007 in the Korean Intellectual Property Office, the disclosure of which is incorporated herein in its entirety by reference.

### BACKGROUND OF THE INVENTION

1. Field of the Invention

The present invention relates to a hydraulic circuit for heavy equipment having a variable control device, which can variably control flow rate and operating pressure required for an option attachment, such as a hammer, that is optionally attached to an excavator in accordance with working conditions.

More particularly, the present invention relates to a hydraulic circuit for heavy equipment having a variable control device, which is provided with variable relief valves installed inside a main control valve (MCV) and having a built-in proportional control function so as to variably control operating pressure and flow rate of a replaced option attachment, and variably control pressure of the variable relief valve in accordance with selection of an option working mode preset on a monitor (e.g., a cluster or the like) provided beside an operator's seat.

2. Description of the Prior Art

For the multipurpose use of heavy equipment, such as an excavator, a bucket may be taken away from the heavy equipment, and an option attachment, such as a hammer, may be attached to the heavy equipment in accordance with working conditions. In this case, the operating pressure and the flow rate required for the option attachment may differ in accordance with the use purpose of the option attachment or a manufacturing company of the option attachment. Accordingly, the relief pressure of a hydraulic circuit may be variably controlled so as to supply the operating pressure required for the replaced option attachment.

As illustrated in FIG. 1, a conventional hydraulic circuit for heavy equipment having a variable control device includes at least one variable displacement hydraulic pump 1; a main relief valve 2, installed on an upstream side of a discharge flow path of the hydraulic pump 1, for draining a part or all parts of hydraulic fluid to a hydraulic tank T if overload exceeding a preset pressure is generated in the hydraulic circuit; an option attachment 3 (e.g., a hammer, a crusher, a shear, or the like) connected to the hydraulic pump 1; a main control valve (MCV) 5 installed in a flow path between the hydraulic pump 1 and the option attachment 3 and having an option spool 4 for controlling start, stop, and direction change of the option attachment 3; port relief valves 6 and 7 installed in a supply flow path and a return flow path between the option spool 4 and the option attachment 3, respectively (i.e., installed inside the main control valve 5); and variable relief valves 9 and 10 (each of which performs functions of an electronic proportional valve and a relief valve), installed on an option line 11 (which is a high-pressure line between the options spool 4 and the option attachment 3) (i.e., installed outside the main control valve 5), for variably controlling relief pressure required for the option attachment 3 in accordance with an electric signal from a controller (V-ECU) 8.

Accordingly, in order to perform an option work, a bucket is taken away from the heavy equipment, and an option attachment, such as a hammer, is attached to the heavy equipment. In this state, an electric signal for a corresponding working mode (which has already been set to suit the option attachment) is inputted from the controller 8 to the variable relief valves 9 and 10 through manipulation of a corresponding switch provided beside the operator' seat. Accordingly, a relief pressure corresponding to the input electric signal is generated by the variable relief valves 9 and 10, and thus the operating pressure and the flow rate required for the option attachment 3 can be supplied thereto.

As illustrated in FIGS. 1 and 2, according to the conventional hydraulic circuit, since the variable relief valves 9 and 10 are separated from the main control valve 5 to form a separate block, the structure of hydraulic pipes for mutually connecting the main control valve 5, the variable relief valves 9 and 10, and working devices is complicated, and this causes the cost for manufacturing and assembling the structure to be increased.

Also, since the variable relief valves 9 and 10, each having functions of an electronic proportional valve and a relief valve, and related pipes are connected to an option line 11, sufficient space to connect the corresponding valves and pipes therein is not secured, and thus the utility and workability is degraded.

Also, since the variable relief valves 9 and 10 and the related pipes are additionally connected to the option line 11 arranged outside the main control valve 5, the number of corresponding components is increased, and thus the manufacturing cost is also increased.

### SUMMARY OF THE INVENTION

Accordingly, the present invention has been made to solve the above-mentioned problems occurring in the prior art while advantages achieved by the prior art are maintained intact.

One object of the present invention is to provide a hydraulic circuit for heavy equipment having a variable control device, which can simplify the construction of hydraulic pipes and thus can reduce the manufacturing cost by installing variable relief valves for variably controlling operating pressure and flow rate of an option attachment inside a main control valve and variably controlling pressure of the variable relief valves through an operator's selection of a preset option working mode in an operator's seat.

Another object of the present invention is to provide a hydraulic circuit for heavy equipment having a variable control device, which can improve the utility and workability by securing sufficient space to install variable relief valves and related valves through unification of the variable relief valves and port relief valves inside a main control valve.

In order to accomplish these objects, there is provided a hydraulic circuit for heavy equipment having a variable control device, according to an embodiment of the present invention, which includes at least one variable displacement hydraulic pump; a main relief valve installed on an upstream side of a discharge flow path of the hydraulic pump; an option attachment connected to the hydraulic pump; a main control valve installed in a flow path between the hydraulic pump and the option attachment, and having an option spool for controlling start, stop, and direction change of the option attachment; port relief valves, installed inside the main control valve, for being proportionally controlled so as to variably control relief pressure required for the option attachment in accordance with pilot signal pressure inputted from an outside; and a proportional relief valve, installed outside the main control valve, for variably controlling the pilot signal pressure inputted to the port relief valves in accordance with an electric signal inputted from an outside.

In a preferred embodiment of the present invention, the hydraulic circuit for heavy equipment having a variable control device further includes a control device for displaying a preset option working mode corresponding to operating pressure and flow rate required for the option attachment so that the electric signal inputted to the proportional relief valve is monitored and controlled by an operator in an operator's seat.

### BRIEF DESCRIPTION OF THE DRAWINGS

The above and other objects, features and advantages of the present invention will be more apparent from the following detailed description taken in conjunction with the accompanying drawings, in which:

FIG. 1 is a circuit diagram of a conventional hydraulic circuit for heavy equipment having a variable control device;

FIG. 2 is a schematic view showing a pipe arrangement of a conventional hydraulic circuit;

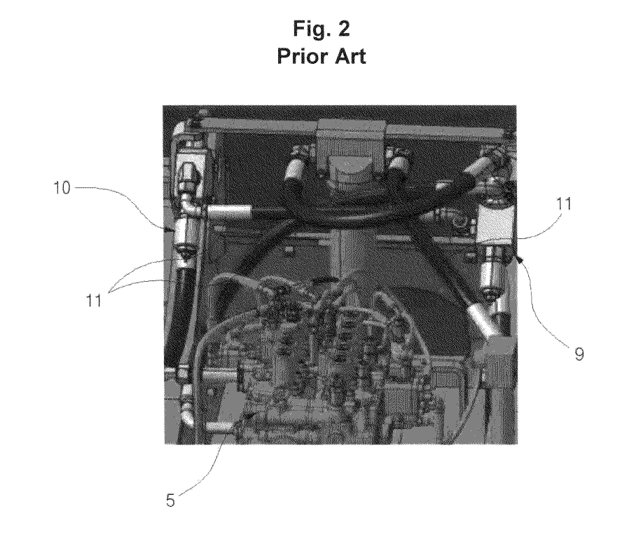

FIG. 3 is a circuit diagram of a hydraulic circuit for heavy equipment having a variable control device; and

FIG. 4 is a schematic view showing a pipe arrangement of a hydraulic circuit according to an embodiment of the present invention.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

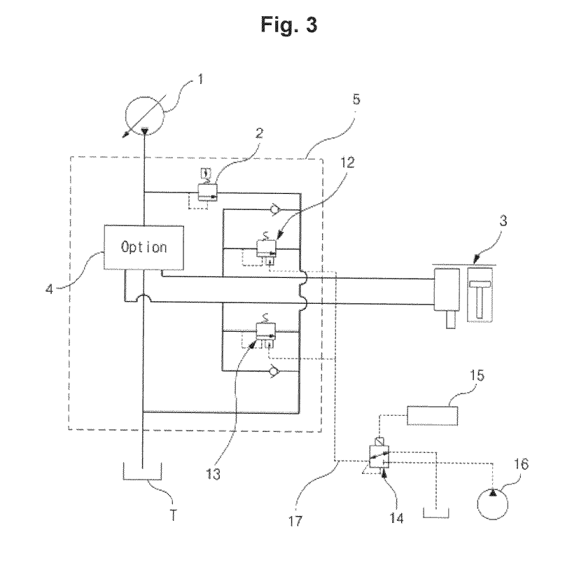

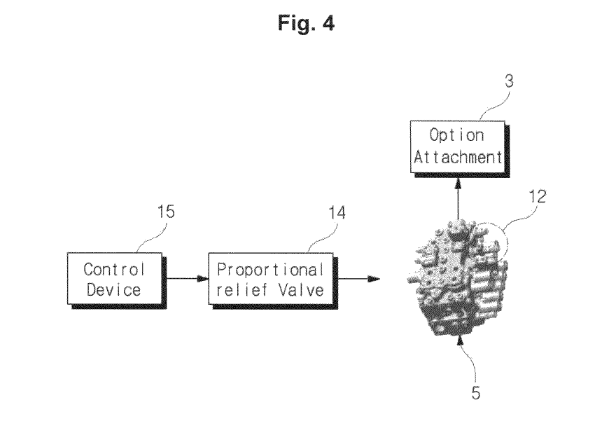

As illustrated in FIGS. 3 and 4, a hydraulic circuit for heavy equipment having a variable control device according to an embodiment of the present invention includes at least one variable displacement hydraulic pump 1; a main relief valve 2, installed on an upstream side of a discharge flow path of the hydraulic pump 1, for draining a part or all parts of hydraulic fluid to a hydraulic tank T if overload exceeding a preset pressure is generated in the hydraulic circuit; an option attachment 3 (e.g., a hammer, a crusher, a shear, or the like) connected to the hydraulic pump 1; a main control valve (MCV) 5 installed in a flow path between the hydraulic pump 1 and the option attachment 3 and having an option spool 4 for controlling start, stop, and direction change of the option attachment 3; port relief valves 12 and 13 (each of which performs functions of a proportional relief valve and a relief valve), installed inside the main control valve 5, for being proportionally controlled so as to variably control relief pressure required for the option attachment 3 in accordance with pilot signal pressure inputted from an outside; and a proportional relief valve (PPRV) 14 (which converts an electric signal into a hydraulic signal), installed outside the main control valve 5, for variably controlling the pilot signal pressure inputted to the port relief valves 12 and 13 in accordance with an electric signal inputted from an outside.

The hydraulic circuit for heavy equipment having a variable control device according to an embodiment of the present invention further includes a control device 15 (e.g., a combination of an ECU that performs a control function and a cluster that performs a monitor function) for displaying a preset option working mode corresponding to operating pressure and flow rate required for the option attachment 3 so that the electric signal inputted to the proportional relief valve 14 is monitored and controlled by an operator in an operator's seat (not illustrated).

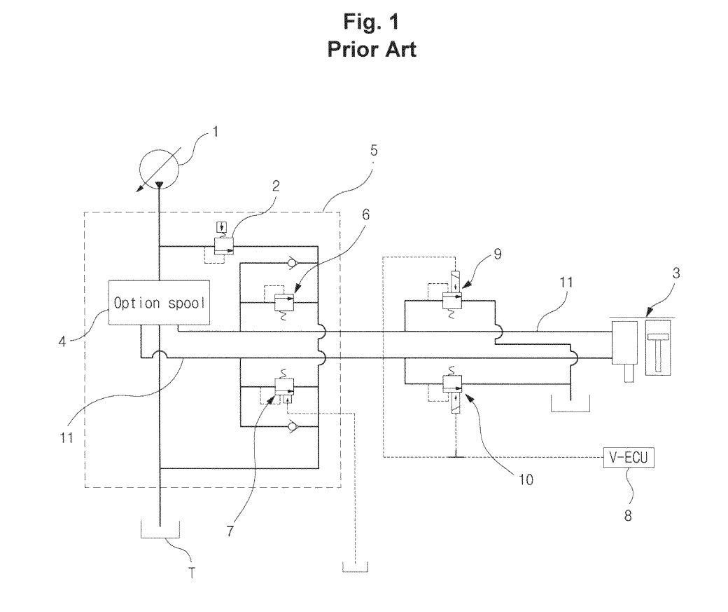

In this case, since the construction including the variable displacement hydraulic pump 1, the main relief valve 2, the option attachment 3, the option spool 4, the main control valve 5, and the like, is substantially the same as that illustrated in FIG. 1, the detailed description thereof will be omitted.

In the drawing, the reference numeral 16 denotes a pilot pump for supplying pilot signal pressure to the port relief valves 12 and 13.

Hereinafter, the operation of the hydraulic circuit for heavy equipment having a variable control device according to an embodiment of the present invention will be described with reference to the accompanying drawings.

As illustrated in FIGS. 3 and 4, in order to perform an option work in accordance with working conditions, a bucket is taken away from the excavator, and an option attachment, such as a hammer, is attached to the excavator. In this state, an option working mode preset in the control device 15 having a display function (e.g., a cluster having an ECU function) is selected by an operator in an operator' seat. In the option working mode of the control device 15, the operating pressure and the flow rate, which are preset to correspond to the replaced option attachment, are displayed.

That is, if an operator selects the preset option working mode through the control device 15, an electric signal corresponding to the selected option working mode is inputted to the proportional relief valve 14. Accordingly, pilot signal pressure being supplied from the pilot pump 16 to the port relief valves 12 and 13 is controlled, corresponding to a current value inputted to the proportional relief valve 14. That is, the proportional relief valve 14 controls the pilot signal pressure being supplied to the port relief valves 12 and 13 in accordance with the electric signal inputted from an outside.

Accordingly, relief pressure of the port relief valves 12 and 13 can be variably controlled in accordance with the pilot signal pressure (i.e. secondary pressure) being supplied to the port relief valves 12 and 13 through the proportional relief valve 14 and a pilot flow path.

Hydraulic fluid from the variable displacement hydraulic pump 1 is supplied to the option attachment 3 via the option spool 4 of the main control valve. In this case, if overload exceeding the set pressure of the port relief valves 12 and 13 is generated during the operation of the option attachment 3, a part or all parts of the hydraulic fluid are drained into a hydraulic tank T.

As described above, according to the present invention, since the port relief valves 12 and 13, each of which performs functions of the proportional relief valve and the relief valve, are installed inside the main control valve 5 (the port relief valves 12 and 13 are installed in a position where the conventional port relief valves 6 and 7 are installed (See FIGS. 3 and 4)), a separate space for installing the port relief valves 12 and 13 is not required, and thus the number of components and the manufacturing cost can be reduced.

By contrast, according to the conventional hydraulic circuit of in FIG. 1, since the port relief valves 6 and 7 are installed inside the main control valve 5 and the variable relief valves 9 and 10 are installed outside the main control valve 5, the pipe structure for connecting the above-described valves is complicated to degrade the workability and utility.

In addition, the proportional relief valve 14 for controlling the pilot signal pressure being supplied to the port relief valves 12 and 13 can be controlled through the input of an electric signal from an outside of the main control valve 5. Accordingly, the construction of the hydraulic system is simplified, and thus the installation cost can be reduced.

On the other hand, in the embodiment of the present invention, it is exemplified that the hydraulic circuit for heavy equipment having a variable control device is applied to an option attachment. However, the hydraulic circuit for heavy equipment having a variable control device according to the present invention can also be applied to a working device, such as a boom, an arm, and the like, and construction equipment, such as a loader, a dozer, and the like.

As described above, the hydraulic circuit for heavy equipment having a variable control device according to the embodiment of the present invention has the following advantages.

The variable relief valves for variably controlling the operating pressure and the flow rate of an option attachment are installed inside the main control valve, and, the pressure of the variable relief valves is variably controlled through the operator's selection of a preset option working mode, so that the construction of hydraulic pipes, the number of corresponding components, and the manufacturing cost can be reduced.

Also, sufficient space to install the variable relief valves and the port relief valves is secured through unification of the variable relief valves and port relief valves inside a main control valve, and thus the utility and workability can be improved.

Although preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A hydraulic circuit for heavy equipment having a variable control device, comprising:
at least one variable displacement hydraulic pump;
a main relief valve installed on an upstream side of a discharge flow path of the hydraulic pump;
an option attachment connected to the hydraulic pump;
a main control valve installed in a flow path between the hydraulic pump and the option attachment, and having an option spool for controlling start, stop, and direction change of the option attachment;
port relief valves, installed inside the main control valve, for being proportionally controlled so as to variably control relief pressure required for the option attachment in accordance with pilot signal pressure inputted from an outside; and
a proportional relief valve, installed outside the main control valve, for variably controlling the pilot signal pressure inputted to the port relief valves in accordance with an electric signal inputted from an outside.

2. The hydraulic circuit of claim 1, further comprising a control device for displaying a preset option working mode corresponding to operating pressure and flow rate required for the option attachment so that the electric signal inputted to the proportional relief valve is monitored and controlled by an operator in an operator's seat.
